(19) United States
(12) Patent Application Publication
(10) Pub. No.: US 2004/0181423 A1
(43) Pub. Date: Sep. 16, 2004

(54) Parts integrated control system and parts sales mode control system adaptable to life cycle

(76) Inventors: Kiyomi Shiyouji, Tokyo (JP); Takashi Satou, Tokyo (JP); Yuuichi Abe, Tokyo (JP); Yasuo Wakui, Tokyo (JP); Wataru Annaka, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/626,861

(22) Filed: Jul. 25, 2003

(30) Foreign Application Priority Data
Jul. 25, 2002 (JP) 2002-216180

(51) Int. Cl. G06F 17/60

(52) U.S. Cl. 705/1

(57) ABSTRACT

A system is disclosed, which comprises a step of extracting parts data having been newly recorded in a master database (10a) within a certain period of time to copy extracted new parts data into a parts integration database (20a), a step of comparing the new parts data with existing parts data to allow an examiner to examine whether the integration of the existing parts and the new parts and/or the change of a sales mode is possible or not, a step of sending a request to approve a resulting judgement to an authorized approver terminal device (42), a step of allowing an authorized approver to determine the possibility or not of the integration of the existing parts and the new parts and/or the change of the sales mode, and a step of providing integrated parts data and/or changed sales mode data by updating the parts data in the master database (10a) on the basis of approval data. Thus, the system is configured to enable the approval for the integration of the parts and/or the change of the sales mode and the communication of data on the integration of the parts and/or the change of the sales mode to be performed in a shorter period of time.

### TECHNICAL FIELD

This invention relates to a parts integrated control system and a parts sales mode control system that are adaptable to a life cycle. More specifically, the present invention relates to a system suited for automobile makers, for instance, in performing an integrated control of or controlling a sales mode of automobile parts of the automobile makers in accordance with the life cycle.

### BACKGROUND ART

Generally, brand makers strive to improve service to users by getting ready for repair parts (service parts) of commercial products simultaneously with marketing these commercial products.

However, in the brand makers such as automobile makers, for instance, the number of sales accounts (number of parts) required to control the parts as the repair parts is expanding in increments of great numbers as many as about 50,000 parts per year. In addition, the brand makers need to supply to commercial product users the repair parts of the commercial products such as automobiles whose commercial product lives are long, although the commercial products become outdated. For this reason, some of the parts would be drifted toward difficulties in supplying.

In this connection, the brand makers have been making efforts to keep only the sales accounts of the repair parts including commercially available parts serviceable as much as possible in such a way as to integrate the sales accounts of the parts into one another (to have parts A of an old type and parts B of a new type for common use and so on, for instance) in consideration of the degree of user's satisfaction together with how new commercial products change their characteristics on a parts basis with the lapse of years after the new commercial products have been put into a market.

Alternatively, the brand makers also have been taking steps to change the sales mode on the parts depending on the kind of parts with the lapse of time (in such a way that the sales mode on preliminarily mass-produced parts available for the new commercial products is changed into a make-to-order sales method with the lapse of time after the new commercial products have been put into the market).

Specifically, in Japanese Patent Laid-open No. 7-271881, there is disclosed an unnecessary account erasing system in banks. In Japanese Patent Laid-open No. 2001-043451, there is disclosed a control system for member credit card point accounts serviceable for member customers in spending credit points, which are provided for the member customers, for shopping. In Japanese Patent Laid-open No. 2001-243350, there is disclosed a method for controlling a plurality of accounts in a system for transactions with credit cards. In Japanese Patent Laid-open No. 2001-351042, there is disclosed a credit limit control/credit inquiry/credit sales system for supporting credit transactions between dealer members for transactions of building materials. In Japanese Patent Laid-open No. 2002-007675, there is disclosed a system for storing business information to consider the stored business information in relation to business or operation strategies. In Japanese Patent Laid-open No. 2002-049746, there is disclosed a system useful for a bank customer information control system in handling a change of customer's account from one branch of a bank, with which a customer has an account, to another branch by reason of a change of customer's address in such a way as to continuously control the customer's account with the bank branch in a service area covering the new address of the customer. In Japanese Patent Laid-open No. 2002-117117, there is disclosed a system for an exchange of information and a settlement on apparel products between a sender of an order and a receiver of the order over Internet. In Japanese Patent Laid-open No. 2002-140629, there is disclosed a sales control system adaptable to a sales using a communication network in automatically controlling a transfer of an amount of purchase money from a purchase offerer to a specified account by the appointed time, a cancel of the purchase before the appointed time and others. However, it is to be noted that any of the above publications makes no mention of a configuration of the present invention, which will be described later.

<Problems 1 to be solved>

As described above, the brand makers have been making efforts to integrate the sales accounts of the parts into one another in consideration of the degree of user's satisfaction together with how the new commercial products change their characteristics on a parts basis with the lapse of years after the new commercial products have been put into the market. However, in performing an operation of integrating the sales accounts as described above, it is necessary to meet with an approval of an authorized approver as to the possibility or not of integration.

In addition, the resulting information on the integration (information representing a necessity to have parts A of an old type and parts B of a new type for common use and other information, for instance) needs to be communicated to related departments (in-maker related departments, dealers and others, for instance).

Conventionally, the above approval and communication operations have been performed with paper forms.

For this reason, a problem has been presented, in which the above approval and communication operations take a long time.

Accordingly, a first object of the present invention is to provide a parts integrated control system adaptable to a life cycle, thereby solving the above problems so as to enable the above approval and communication operations to be performed in a shorter period of time.

<Problems 2 to be solved>

As described above, the brand makers have been taking steps to change the sales mode on the parts of the new commercial products depending on the kind of parts with the lapse of years after the new commercial products have been put into the market. However, in changing the sales mode on the parts as described above, it is necessary to meet with an approval of an authorized approver as to the possibility or not of the change of the sales mode on the parts.

In addition, the resulting information on the change of the sales mode (information representing a necessity to produce parts C after the reception of an order and other information, for instance) needs to be communicated to related departments (in-maker related departments, dealers and others).

Conventionally, the above approval and communication operations have been performed with paper forms.

For this reason, a problem has been presented, in which the above approval and communication operations take a long time.

Accordingly, a second object of the present invention is to provide a parts sales mode control system adaptable to a life cycle, thereby solving the above problems so as to enable the above approval and communication operations to be performed in a shorter period of time.

### DISCLOSURE OF THE INVENTION

In order to attain the above first object, a parts integrated control system adaptable to a life cycle according to the present invention comprises a master database, in which data on all parts including parts for new commercial products is previously existing, and which may be shared among related department terminal devices; a parts integration database, which permits an exchange of data to and from the master database; and an examiner terminal device and an authorized approver terminal device, which are connectable to the parts integration database, wherein the parts integrated control system also comprises:

an extraction step of extracting parts related-data having been newly recorded in the master database within a certain period of time to copy extracted new parts data into the parts integration database;

an examination step of comparing the new parts data obtained through the extraction step with existing parts-related data to allow an examiner to examine whether the integration of the existing parts and the new parts is possible or not;

an approval request step of sending a request to approve a resulting judgement, which is passed by the examiner through the examination step when the integration of the existing parts and the new parts is judged to be possible, to the authorized approver terminal device dedicated to an authorized approver who is authorized to make a final decision on the judgement of the examiner;

a determination step of allowing the authorized approver to determine the possibility or not of the integration of the existing parts and the new parts in accordance with the approval request step; and

an updating step of providing integrated parts data by updating the new parts data and/or the existing parts-related data in the master database on the basis of approval data obtained at a time when an approval for the integration of the existing parts and the new parts is determined through the determination step.

The parts integrated control system adaptable to the life cycle has the following operational effects.

Specifically, when the integration of the existing parts and the new parts is judged by the examiner to be possible, the request to approve the resulting judgement is sent to the authorized approver terminal device. Thus, all the authorized approver has to do is to determine the possibility or not of the integration of the existing parts and the new parts in response to the above request to approve, so that an approval operation may be performed in a shorter period of time.

When the approval for the integration of the existing parts and the new parts is determined, the integrated parts data is provided by updating the new parts data and/or the existing parts-related data in the master database on the basis of the data on the approval for the integration. In addition, the master database may be shared among the related department terminal devices, so that an access to the master database will be enough for the related departments to obtain information on the above integration.

Accordingly, communication of the information on the above integration may be performed in an extremely shorter period of time.

As described above, the parts integrated control system of the present invention enables the approval and communication operations to be performed in a shorter period of time.

The parts integrated control system of the present invention further has the following operational effects.

Specifically, the examination by the examiner is performed with data having been already copied from the master database into the parts integration database. In addition, when the approval for the integration of the existing parts and the new parts is determined by the authorized approver, the integrated parts data is provided by updating the new parts data and/or the existing parts-related data in the master database on the basis of the data on the approval for the integration. Thus, a situation may be prevented, in which a change of the data on the parts that are being under examination into the integrated parts data occurs by updating from some causes (mistakes in operation by the examiner and other causes, for instance) without receiving the approval of the authorized approver.

The examination by the examiner follows the extraction of parts-related data having been newly recorded in the master database within a certain period of time, and as a result, the examination at regular intervals may be ensured.

Accordingly, a situation may be also prevented, in which the number of parts accounts (number of parts) existing in the master database is increasing too much uselessly.

In the above parts integrated control system adaptable to the life cycle, a parts integrated control system adaptable to a life cycle according to the present invention further comprises a distribution step of distributing the integrated parts data provided by updating through the updating step to the related department terminal devices.

The parts integrated control system adaptable to the life cycle further comprises the distribution step of distributing the integrated parts data provided by updating through the updating step to the related department terminal devices, so that the communication of information to the related departments may be ensured.

In the above parts integrated control system adaptable to the life cycle, a parts integrated control system adaptable to a life cycle according to the present invention further comprises a recording step of recording, into the parts integration database, data on a resulting judgement passed by the examiner through the examination step when the integration of the existing parts and the new parts is judged to be impossible, together with a reason to judge the integration to be impossible.

The above parts integrated control system adaptable to the life cycle further comprises the recording step of recording, into the parts integration database, the data on the resulting judgment passed by the examiner through the examination step when the integration of the existing parts and the new parts is judged to be impossible, together with the reason to judge the integration to be impossible, so that the above reason to judge the integration to be impossible may be referred to in re-examining the integration of the existing parts and the new parts (or the existing parts) in the future.

Accordingly, if the reason to judge the integration to be impossible is already settled in the future examination, for instance, the integration once judged to be impossible might be turned into the acceptable integration.

As a result, a more rapid judgement on the possibility or not of the integration may be ensured.

In the above parts integrated control system adaptable to the life cycle, a parts integrated control system adaptable to a life cycle according to the present invention further comprises a recording step of recording, into the parts integration database, data on a resulting rejection determined by the authorized approver through the determination step when the approval for the integration of the existing parts and the new parts is rejected, together with a reason to reject the approval for the integration.

The above parts integrated control system adaptable to the life cycle further comprises the recording step of recording, into the parts integrated database, the data on the resulting rejection determined by the authorized approver through the determination step when the approval for the integration of the existing parts and the new parts is rejected, together with the reason to reject the approval for the integration, so that the above reason to reject the approval for the integration may be referred to in re-examining the integration of the existing parts and the new parts (or the existing parts) in the future.

Accordingly, if the reason to reject the approval for the integration is already settled in the future examination, for instance, the integration once judged to be impossible might be turned into the acceptable integration.

As a result, a more rapid judgement on the possibility or not of the integration may be ensured.

In order to attain the above second object, a parts sales mode control system adaptable to a life cycle according to the present invention comprises a master database, in which data on all parts including parts for new commercial products are previously existing, and which may be shared among related department terminal devices; a parts sales mode control database, which permits an exchange of data to and from the master database; and an examiner terminal device and an authorized approver terminal device, which are connectable to the parts sales mode control database, wherein the parts sales mode control system also comprises:

an extraction step of extracting parts-related data having been newly recorded in the master database within a certain period of time to copy the extracted new parts data into the parts sales mode control database;

an examination step of comparing the new parts data obtained through the extraction step with existing parts-related data to allow an examiner to examine whether a change of a sales mode on the existing parts is possible or not;

an approval request step of sending a request to approve a resulting judgment, which is passed by the examiner through the examination step when the change of the sales mode on the existing parts is judged to be possible, to the authorized approver terminal device dedicated to an authorized approver who is authorized to make a final decision on the above judgment of the examiner;

a determination step of allowing the authorized approver to determine the possibility or not of the change of the sales mode on the existing parts in accordance with the approval request step; and

an updating step of providing changed sales mode data by updating the existing parts sales mode-related data in the master database on the basis of approval data obtained at a time when an approval for the change of the sales mode on the existing parts is determined through the determination step.

The parts sales mode control system adaptable to the life cycle has the following operational effects.

Specifically, when the change of the sales mode on the existing parts is judged by the examiner to be possible, the request to approve the resulting judgment is sent to the authorized approver terminal device. Thus, all the authorized approver has to do is to determine the possibility or not of the change of the sales mode in response to the above request to approve, so that an approval operation may be performed in a shorter period of time.

When the approval for the change of the sales mode is determined, the changed sales mode data is provided by updating the existing parts sales mode-related data in the master database on the basis of the data on the approval for the change of the sales mode. In addition, the master database may be shared among the related department terminal devices, so that an access to the master database will be enough for the related departments to obtain information on the change of the sales mode.

Accordingly, the communication of the information on the change of the sales mode may be performed in a shorter period of time.

As described above, the parts sales mode control system enables the approval and communication operations to be performed in a shorter period of time.

The parts sales mode control system further has the following operational effects.

Specifically, the examination by the examiner is performed with data having been copied from the master database into the parts sales mode control database. In addition, when the approval for the change of the sales mode is determined by the authorized approver, the changed sales mode data is provided by updating the existing parts sales mode-related data in the master database on the basis of the data on the approval for the change of the sales mode. Thus, a situation may be prevented, in which a change of the data on the parts that are being under examination into the changed sales mode data by updating from some causes (mistakes in operation by the examiner and other causes, for instance) without receiving the approval of the authorized approver.

The examination by the examiner follows the extraction of the parts-related data having been newly recorded in the master database within a certain period of time, and as a result, the examination at regular intervals may be ensured.

Accordingly, a more rapid change of the sales mode may be ensured.

In addition, the change of the sales mode involves the suspension of the sales, so that a situation may be also prevented, in which the number of parts accounts (number of parts) existing in the master database is increasing too much uselessly.

In the above parts sales mode control system adaptable to the life cycle, a parts sales mode control system adaptable to a life cycle further comprises a distribution step of distributing the changed sales mode data provided by updating through the updating step to the related department terminal devices.

The parts sales mode control system adaptable to the life cycle further comprises the distribution step of distributing the changed sales mode data provided by updating through the updating step to the related department terminal devices, so that the communication of information to the related departments may be ensured.

In the parts sales mode control system adaptable to the life cycle, a parts sales mode control system adaptable to a life cycle further comprises a recording step of recording, into the parts sales mode control database, data on a resulting judgement passed by the examiner through the examination step when the change of the sales mode on the existing parts is judged to be impossible, together with a reason to judge the change of the sales mode to be impossible.

The parts sales mode control system adaptable to the life cycle further comprises the recording step of recording, into the parts sales mode control database, the data on the resulting judgement passed by the examiner through the examination step when the change of the sales mode on the existing parts is judged to be impossible, together with the reason to judge the change of the sales mode to be impossible, so that the above reason to judge the change of the sales mode to be impossible may be referred to in re-examining the change of the sales mode in the future.

Accordingly, if the above reason to judge the change of the sales mode to be impossible is already settled in the future examination, for instance, the sales mode once judged to be unchangeable might be turned into the changeable sales mode.

As a result, a more rapid judgement on the possibility or not of the change of the sales mode may be ensured.

In the above parts sales mode control system adaptable to the life cycle, a parts sales mode control system adaptable to a life cycle further comprises a recording step of recording, into the parts sales mode control database, data on a resulting rejection determined by the authorized approver through the determination step when the approval for the change of the sales mode on the existing parts is rejected, together with a reason to reject the approval for the change of the sales mode.

The parts sales mode control system adaptable to the life cycle further comprises the recording step of recording, into the parts sales mode control database, the data on the resulting rejection determined by the authorized approver through the determination step when the approval for the change of the sales mode on the existing parts is rejected, together with the reason to reject the approval for the change of the sales mode, so that the above reason to reject the approval for the change of the sales mode may be referred to in re-examining the change of the sales mode in the future.

Accordingly, if the reason to reject the approval for the change of the sales mode is already settled in the future examination, for instance, the sales mode once judged to be unchangeable might be turned into the changeable sales mode.

As a result, a more rapid judgement on the possibility or not of the change of the sales mode may be ensured.

It is to be noted that the change of the sales mode involves the suspension of sales.

### BRIEF DESCRIPTION OF THE DRAWINGS

FIG. 1 is a system configuration diagram showing an embodiment of a parts integrated control system and a parts sales mode control system that are adaptable to a life cycle according to the present invention;

FIG. 2 is a flowchart showing how the above systems are operated and work; and

FIG. 3 is a flowchart showing how the above systems are operated and work.

### BEST MODE FOR EMBODYING THE INVENTION

Hereinafter will be described embodiments of the present invention with reference to the accompanying drawings.

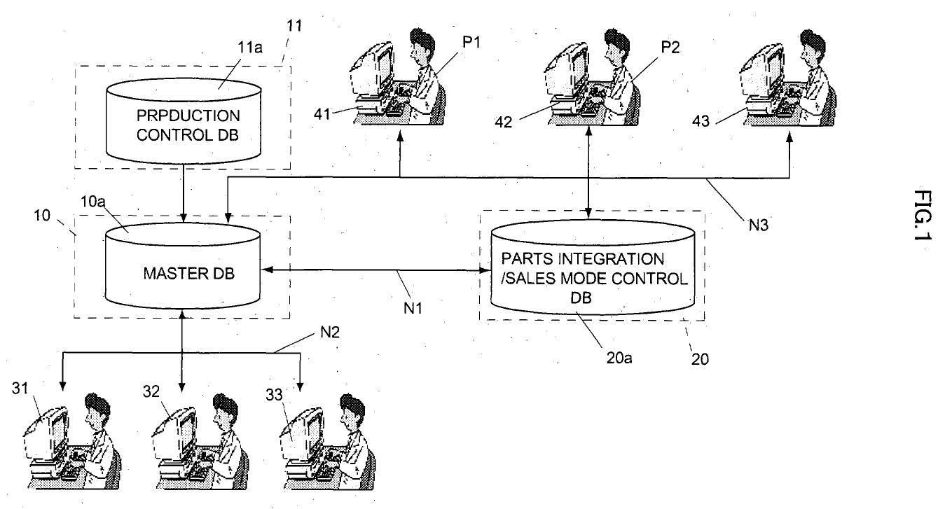

FIG. 1 is a system configuration diagram showing an embodiment of a parts integrated control system and a parts sales mode control system that are adaptable to a life cycle according to the present invention.

The embodiment of FIG. 1 will be illustrated on the assumption that a certain automobile maker puts each of the above systems to use.

In FIG. 1, reference numeral 10 designates a master database system (which is a system having a database, and the same shall apply hereinafter). The master database system 10 has a master database 10a, in which data (electronic data) on all parts including parts for new commercial products of the automobile maker concerned is previously existing. Reference numeral 11 designates a production control database system, and there is configured a system, which may store, in a database 11a, data on automobiles and parts thereof such as data on prototype drawings, mass production drawings, production control, supplying and purchase required for the automobile maker concerned, and also permits communication of the data described above.

Data transferred from the production control database 11a to the master database 10a is only parts-related data, which is then stored in the master database 10a.

A parts integration/sales mode control database system 20 is connected to the master database system 10 online or via a network N1, thereby enabling an exchange of data between the master database 10a of the master database system 10 and the parts integration/sales mode control database 20a.

In addition, related department terminal devices 31, 32 and 33 are connected to the master database system 10 online or via a network N2, thereby allowing the master database 10a to be shared among these related department terminal devices.

Specifically, the related department terminal devices 31, 32 and 33 are respectively a terminal device installed in a parts dealer and others, a terminal device installed in a parts maker, and a terminal device installed in an overseas department, for instance. Although there are shown only three terminal devices in FIG. 1, it is to be noted that a larger number of terminal devices are installed at need as a matter of fact.

The master database system 10 is also configured to establish communication with the related department terminal devices, as will be described later.

An examiner terminal device 41 and an authorized approver terminal device 42 are at least connected to the parts integration/sales mode control database system 20 online or via a network N3. In the present embodiment, a related department terminal device 43 in the automobile maker is also connected to the parts integration/sales mode control database system 20. Although there are shown only three terminal devices in FIG. 1, it is to be noted that a larger number of terminal devices are installed at need as a matter of fact. Each of the terminal devices 31 to 33 and 41 to 43 may be configured with a personal computer. Alternatively, the networks N1 to N3 may also share a single network (Internet, for instance).

How the above systems are operated and work will next be described with reference to FIGS. 1, 2 and 3.

<Parts Integrated Control>

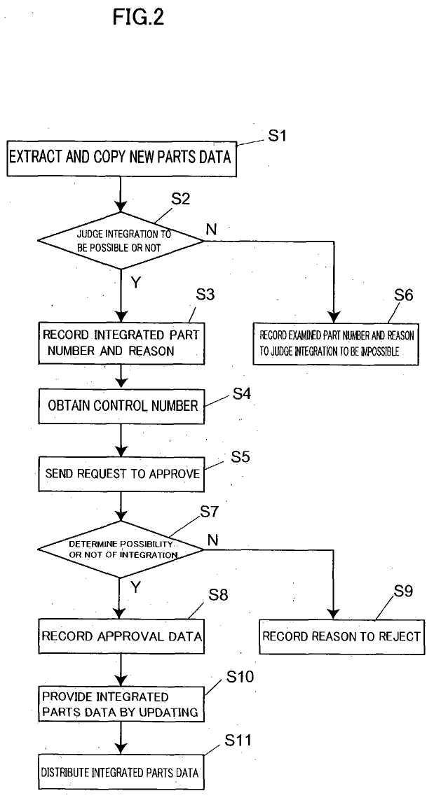

(i) An examiner P1 (see FIG. 1) makes an examination of integration of parts with one's own terminal device 41 in such a way as to access the master database 10a at regular intervals (every week, month and others, for instance). The examiner P1 extracts parts-related data having been newly recorded in the master database 10a within a certain period of time (i.e., the above period of time such as a week and a month), and then copies extracted new parts data into the parts integration/sales mode control database 20a (This step is called an extraction step. See Step S1 in FIG. 2).

(ii) With one's own terminal device 41, the examiner P1 makes a comparison between the new parts data obtained through the extraction step S1 and existing parts-related data previously existing in the parts integration/sales mode control database 20a, and then examines whether the integration of the existing parts and the new parts is possible or not (This step is called an examination step. See Step S2 in FIG. 2).

(iii) When the integration of the existing parts and the new parts is judged by the examiner P1 to be possible in the examination step S1, an integrated part number and a reason to judge the integration to be possible are at least recorded as data on a resulting judgement in the parts integration/sales mode control database 20a (Step S3). Then, a control number (No) is obtained (Step S4).

Then, the data (such as the control number and the resulting judgement) is sent together with a request to approve the above data to the authorized approver terminal device 42 dedicated to an authorized approver P2 who is authorized to make a final decision on the judgement of the examiner (This step is called an approval request step. See Step S5 in FIG. 2).

On the other hand, when the integration of the existing parts and the new parts is judged by the examiner P1 to be impossible in the examination step S2, the number of each part whose possibility or not of the integration has been examined and the reason to judge the integration to be impossible are recorded as data on the resulting judgement in the parts integration/sales mode control database 20a (This step is called a recording step. See Step S6 in FIG. 2).

(iv) Upon receipt of the above request to approve, the authorized approver P2 examines and determines with one's own terminal device 42 whether the above control-numbered integration of the existing parts and the new parts is possible or not (This step is called a determination step. See Step S7 in FIG. 2).

(v) When the approval for the integration of the existing parts and the new parts is determined (the integration is determined) by the authorized approver P2 through the determination step S7, data (such as the above control number and an electronic signature of approval) on the approval for the integration is recorded in the parts integration/sales mode control database 20a (Step S8).

On the other hand, when the approval for the integration of the existing parts and the new parts is rejected (or the integration is judged to be impossible) by the authorized approver P2 through the determination step S7, data on the resulting rejection and a reason to reject the approval for the integration are recorded in the parts integration/sales mode control database 20a (This step is called a recording step. See Step S9 in FIG. 2).

(vi) When recording of the approval data is done through the above step S8, the parts integration/sales mode control database system 20 provides integrated parts data by updating the new parts data and/or the existing parts-related data in the master database 10a on the basis of the approval data (This step is called an updating step. See Step S10 in FIG. 2).

Specifically, the integration of the new parts into the existing parts allows the new parts-related data to be changed into the existing parts-related data. Conversely, the integration of the existing parts into the new parts allows the existing parts-related data to be changed into the new parts-related data.

(vii) When the integrated parts data is provided by updating the new parts data and/or the existing parts-related data through the updating step S10, the master database system 10 performs distribution of the integrated parts data to the related department devices 31 to 33 and 41 to 43 online or via the networks N2 and N3 (This step is called a distribution step. See Step S11 in FIG. 2). Alternatively, the integrated parts data may be also distributed directly from the parts integration/sales mode control database system 20 without passing through the master database system 10.

<Parts sales mode control>

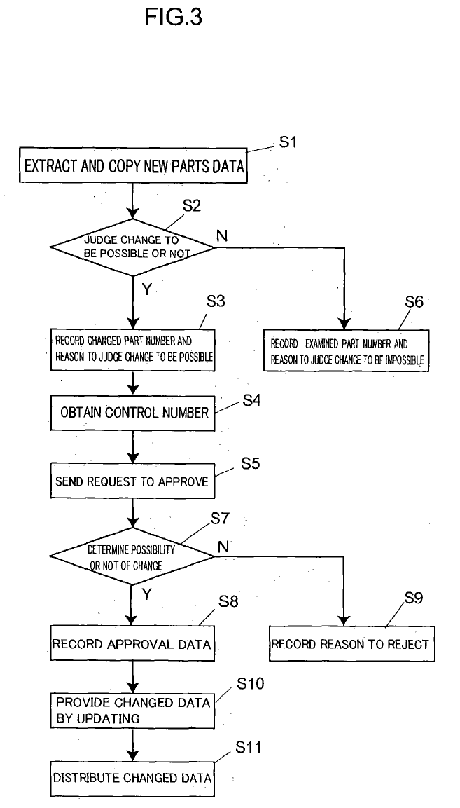

(i) The examiner P1 (See FIG. 1) makes an examination of parts sales mode (including the suspension of sales) with one's own terminal device 41 to access the master database 10a at regular intervals (every week, month and others, for instance). The examiner P1 extracts parts-related data having been newly recorded in the master database 10a within a certain period (i.e., the above period such as a week and a month), and then copies the extracted new parts data into the parts integration/sales mode control database 20a (This step is called an extraction step. See Step S1 in FIG. 3).

(ii) With one's own terminal device 41, the examiner P1 makes a comparison between the new parts data obtained through the extraction step S1 with existing parts-related data previously existing in the parts integration/sales mode control database 20a, and then examines whether a change of the sales mode on the existing parts (a change of the sales mode to a make-to-order method, for instance) is possible or not (This step is called an examination step. See Step S2 in FIG. 3).

In this case, when the integration is judged to be possible as the result of examination on the possibility or not of the integration as described above, for instance, it is also examined whether the sales of the existing parts is suspended or not.

(iii) When the change of the sales mode on the existing parts is judged by the examiner P1 to be possible in the examination step S2, the part number concerned and a reason to judge the change of the sales mode to be possible are at least recorded as data on the resulting judgment in the parts integration/sales mode control database 20a (Step S3 in FIG. 3). Then, a control number is obtained (Step S4 in FIG. 3).

Then, the data (such as the above control number and the resulting judgement) is sent together with a request to approve the above data to the authorized approver terminal device 42 dedicated to the authorized approver P2 who is authorized to make a final decision on the judgment of the examiner (This step is called an approval request step. See Step S5 in FIG. 3).

On the other hand, when the change of the sales mode on the parts concerned is judged by the examiner P1 to be impossible in the examination step S2; the number of parts whose possibility or not of the change of the sales mode has been examined and a reason to judge the change of the sales mode to be impossible are at least recorded as data on the resulting judgement in the parts integration/sales mode control database 20a. (This step is called a recording step. See Step S6 in FIG. 3).

(iv) Upon receipt of the above request to approve, the authorized approver P2 examines and determines with one's own terminal device 42 whether the above control-numbered change of the sales mode on the existing parts is possible or not (This step is called a determination step. See Step S7 in FIG. 3).

(v) When the approval for the change of the sales mode on the existing parts is determined (the change of the sales mode is determined) by the authorized approver P2 through the determination step S7, data (such as the above control number and an electronic signature of approval) on the approval for the change of the sales mode is recorded in the parts integration/sales mode control database 20a (Step S8).

On the other hand, when the approval for the change of the sales mode on the existing parts is rejected (the change of the sales mode is judged to be impossible) by the authorized approver P2 through the determination step S7, data on the resulting rejection and a reason to reject the approval for the change of the sales mode are recorded in the parts integration/sales mode control database 20a (This step is called a recording step. See Step S9 in FIG. 2).

(vi) When recording of the approval data is done through the above step S8, the parts integration/sales mode control database system 20 provides the changed sales mode data by updating the existing parts sales mode-related data in the master database 10a on the basis of the approval data (This step is called an updating step. See Step S10 in FIG. 3).

In addition, when the sales of the parts is suspended, for instance, data on the parts concerned is erased at need.

(vii) When the changed sales mode data is provided by updating the existing parts sales mode-related data through the updating step S10, the master database system 10 performs distribution of the changed sales mode data to the related department terminal devices 31 to 33 and 41 to 43 online or via the networks N2 and N3 (This step is called a distribution step. See Step S11 in FIG. 3). Alternatively, the changed sales mode data may be distributed directly from the parts integration/sales mode control database system 20 without passing through the master database system 10.

The parts integrated control system and/or the parts sales mode control system that are adaptable to the life cycle as described above has the following operational effects.

(a) The parts integrated control system adaptable to the life cycle according to the present embodiment comprises the master database 10a, in which data on all parts including the parts for new commercial products are previously existing, and which may be shared among the related department terminal devices 31 to 33 and 43; the parts integration database 20a, which permits the exchange of data to and from the master database 10a; and the examiner terminal device 41 and the authorized approver terminal device 42, which are connectable to the parts integration database 20a, wherein the parts integrated control system also comprises:

the extraction step S1 of extracting the parts-related data having been newly recorded in the master database 10a within a certain period of time to copy the extracted new parts data into the parts integration database 20a;

the examination step S2 of comparing the new parts data obtained through the extraction step S1 with the existing parts-related data to allow the examiner P1 to examine whether the integration of the existing parts and the new parts is possible or not:

the approval request step S5 of sending the request to approve a resulting judgement, which is passed by the examiner P1 through the examination step S2 when the integration of the existing parts and the new parts is judged to be possible, to the authorized approver terminal device 42 dedicated to the authorized approver P2 who is authorized to make a final decision on the judgement of the examiner;

the determination step S7 of allowing the authorized approver P2 to determine the possibility or not of the integration of the existing parts and the new parts in accordance with the approval request step S5; and

the updating step S10 of providing the integrated parts data by updating the new parts data and/or the existing parts-related data in the master database 10a on the basis of the approval data obtained at a time when the approval for the integration of the existing parts and the new parts is determined through the determination step S7. Accordingly, the parts integrated control system adaptable to the life cycle has the following operational effects.

Specifically, when the integration of the existing parts and the new parts is judged by the examiner P1 to be possible, the request to approve the resulting judgement is sent to the authorized approver terminal device 42. Then, all the authorized approver P2 has to do is to determine the possibility or not of the integration of the existing parts and the new parts in response to the above request to approve, so that an approval operation may be performed in a shorter period of time.

When the approval for the integration of the existing parts and the new parts is determined, the integrated parts data is provided by updating the new parts data and/or the existing parts-related data in the master database 10a on the basis of the data on the approval for the integration. In addition, the master database 10a may be shared among the related department terminal devices 31 to 33 and 41 to 43, so that an access to the master database 10a will be enough for the related departments to obtain information on the above integration.

Thus, the communication of the information on the above integration may be performed in an extremely shorter period of time.

As described above, the parts integrated control system enables the above approval and communication operations to be performed in a shorter period of time.

The parts integrated control system further has the following operational effects.

Specifically, the examination by the examiner P1 is performed with the data having been copied from the master database 10a into the parts integration database 20a. In addition, when the approval for the integration of the existing parts and the new parts is determined by the authorized approver P2, the integrated parts data is provided by updating the new parts data and/or the existing parts-related data in the master database 10a on the basis of the data on the approval for the integration. Thus, a situation may be prevented, in which a change of the data on the parts that are being under examination into the integrated parts data occurs by updating from some causes (mistakes in operation by the examiner P2, and other causes, for instance) without receiving the approval of the authorized approver P3.

In addition, the examination by the examiner P2 follows the extraction of the parts-related data having been newly recorded in the master database 10a within a certain period of time, and as a result, the examination at regular intervals may be ensured.

Thus, a situation may be prevented, in which the number of parts accounts (number of parts) existing in the master database 10a is increasing too much uselessly.

(b) The parts integrated control system further comprises the distribution step S11 of distributing the integrated parts data provided by updating through the updating step S10 to the related department terminal devices 31 to 33 and 41 to 43, so that the communication of the information to the related departments may be ensured.

(c) The parts integrated control system further comprises the recording step S6 of recording, into the parts integration database 20a, the data on the resulting judgement passed by the examiner P1 through the examination step S2 when the integration of the existing parts and the new parts is judged to be impossible, together with the reason to judge the integration to be impossible, so that the above reason to judge the integration to be impossible may be referred to in re-examining the integration of the existing parts and the new parts (or the existing parts) in the future.

Thus, if the reason to judge the integration to be impossible is already settled in the future examination, for instance, the integration once judged to be impossible might be turned into the acceptable integration.

As a result, a more rapid judgement on the possibility or not of the integration may be ensured.

(d) The parts integrated control system further comprises the recording step S9 of recording, into the parts integration database 20a, the data on the resulting rejection determined by the authorized approver P2 through the determination step S7 when the approval for the integration of the existing parts and the new parts is rejected, together with the reason to reject the approval for the integration, so that the above reason to reject the approval for the injection may be referred to in re-examining the integration of the existing parts and the new parts (or the existing parts) in the future.

Thus, if the above reason to reject the approval for the integration is already settled in the future examination, for instance, the integration once judged to be impossible might be turned into the acceptable integration.

As a result, the more rapid judgment on the possibility or not of the integration may be ensured.

(e) The parts sales mode control system adaptable to the life cycle comprises the master database 10a, in which data on all parts including the parts for new commercial products are previously existing, and which may be shared among the related department terminal devices 31 to 33 and 41 to 43; the parts sales mode control database 20a, which permits the exchange of data to and from the master database 10a; and the examiner terminal device 41 and the authorized approver terminal device 42, which are connectable to the parts sales mode control database 20a, wherein the parts sales mode control system also comprises:

the extraction step S1 of extracting the parts-related data having been newly recorded in the master database within a certain period of time to copy the extracted new parts data into the parts sales mode control database 20a;

the examination step S2 of comparing the new parts data obtained through the extraction step S1 with the existing parts-related data to allow the examiner P1 to examine whether the change of the sales mode on the existing parts is possible or not;

the approval request step S5 of sending the request to approve the resulting judgment, which is passed by the examiner P1 through the examination step S2 when the change of the sales mode on the existing parts is judged to be possible, to the authorized approver terminal device 42 dedicated to the authorized approver P2 who is authorized to make a final decision on the judgment of the examiner;

the determination step S7 of allowing the authorized approver P2 to determine the possibility or not of the change of the sales mode on the existing parts in accordance with the approval request step S5; and

the updating step S10 of providing the changed sales mode data by updating the existing parts sales mode-related data in the master database 10a on the basis of the approval data obtained at a time when the approval for the change of the sales mode on the existing parts is determined through the determination step S7. Thus, the parts sales mode control system adaptable to the life cycle has the following operational effects.

Specifically, when the change of the sales mode on the existing parts is judged by the examiner P1 to be possible, the request to approve the resulting judgment is sent to the authorized approver terminal device 42. Thus, all the authorized approver P2 has to do is to determine the possibility or not of the change of the sales mode in response to the above request to approve, so that the approval operation may be performed in a shorter period of time.

When the approval for the change of the sales mode is determined, the changed sales mode data is provided by updating the existing parts sales mode-related data in the master database 10a on the basis of the data on the approval for the change of the sales mode. In addition, the master database 10a may be shared among the related department terminal devices 31 to 33 and 41 to 43, so that an access to the master database 10a will be enough for the related departments to obtain information on the change of the sales mode.

Thus, the communication of information may be performed in an extremely shorter period of time.

As described above, the parts sales mode control system enables the above approval and communication operations to be performed in a shorter period of time.

The parts sales mode control system further has the following operational effects.

Specifically, the examination by the examiner P1 is performed with the data having been copied from the master database 10a into the sales mode control database 20a. In addition, when the approval for the change of the sales mode is determined by the authorized approver P2, the changed sales mode data is provided by updating the existing parts sales mode-related data in the master database 10a. Thus, a situation may be prevented, in which a change of the data on the parts that are being under examination into the changed sales mode data occurs by updating from some causes (mistakes in operation by the examiner P1 and other causes, for instance) without receiving the approval of the authorized approver P2.

In addition, the examination by the examiner P1 follows the extraction of the parts-related data having been newly recorded in the master database 10a within a certain period of time, and as a result, the examination at regular intervals may be ensured.

Thus, the change of the sales mode may be performed rapidly.

In addition, since the change of the sales mode involves the suspension of sales, a situation may be prevented, in which the number of parts accounts (number of parts) existing in the master database 10a is increasing too much uselessly.

(f) The parts sales mode control system further comprises the distribution step S11 of distributing the changed sales mode data provided by updating through the updating step S10 to the related department terminal devices 31 to 33 and 41 to 43, so that the communication of information to the related departments may be ensured.

(g) The parts sales mode control system further comprises the recording step S6 of recording, into the parts sales mode control database 20a, the data on the resulting judgment passed by the examiner P1 through the examination step S1 when the change of the sales mode on the existing parts is judged to be impossible, together with the reason to judge the change of the sales mode to be impossible, so that the above reason to judge the change of the sales mode to be impossible may be referred to in re-examining the change of the sales mode in the future.

Thus, if the above reason to judge the change of the sales mode to be impossible is already settled in the future examination, for instance, the sales mode once judged to be unchangeable might be turned into the changeable sales mode.

As a result, the more rapid judgment on the possibility or not of the change of the sales mode may be ensured.

(h) The parts sales mode control system further comprises the recording step S9 of recording, into the parts sales mode control database 20a, the data on the resulting rejection determined by the authorized approver P2 through the determination step S7 when the approval for the change of the sales mode is rejected, together with the reason to reject the approval for the change of the sales mode, so that the reason to reject the approval for the change of the sales mode may be referred to in re-examining the change of the sales mode in the future.

Thus, if the above reason to reject the approval for the change of the sales mode is already settled in the future examination, for instance, the sales mode once judged to be unchangeable might be turned into the changeable sales mode.

As a result, the more rapid judgment on the possibility or not of the change of the sales mode may be ensured.

While the embodiments of the present invention have been described, it is to be noted that the present invention is not limited to the above embodiments, and various modifications and variations may be made within the true sprit and scope of the invention.

### INDUSTRIAL APPLICABILITY

As described above, the parts integrated control system and/or the parts sales mode control system that are adaptable to the life cycle according to the present invention is useful as a system, which is suited to the automobile makers, for instance, in performing the integrated control of and/or controlling the sales mode of automobile parts of the automobile makers in accordance with the life cycle, thereby enabling the approval and communication operations required for the parts integrated control or the parts sales mode control to be performed in a shorter period of time.

1. A parts integrated control system adaptable to a life cycle, comprising a master database, in which data on all parts including parts for new commercial products is previously existing, and which may be shared among related department terminal devices; a parts integration database, which permits an exchange of data to and from said master database; and an examiner terminal device and an authorized approver terminal device, which are connectable to said parts integration database, wherein said parts integrated control system also comprises:
an extraction step of extracting parts-related data having been newly recorded in said master database within a certain period of time to copy the extracted new parts data into said parts integration database;
an examination step of comparing the new parts data obtained through said extraction step with existing parts-related data to allow an examiner to examine whether the integration of the existing parts and the new parts is possible or not;
an approval request step of sending a request to approve a resulting judgment, which is passed by the examiner through said examination step when the integration of the existing parts and the new parts is judged to be possible, to said authorized approver terminal device dedicated to an authorized approver who is authorized to make a final decision on the judgment of the examiner;
a determination step of allowing the authorized approver to determine the possibility or not of the integration of the existing parts and the new parts in accordance with said approval request step; and
an updating step of providing integrated parts data by updating said new parts data and/or the existing parts-related data in said master database on the basis of approval data obtained at a time when the approval for the integration of the existing parts and the new parts is determined through said determination step.

2. The parts integrated control system adaptable to the life cycle according to claim 1, wherein it further comprises a distribution step of distributing the integrated parts data provided by updating through said updating step to the related department terminal devices.

3. The parts integrated control system adaptable to the life cycle according to claim 1, wherein it further comprises a recording step of recording, into said parts integration database, data on a resulting judgment passed by the examiner through said examination step when the integration of the existing parts and the new parts is judged to be impossible, together with a reason to judge said integration to be impossible.

4. The parts integrated control system adaptable to the life cycle according to claim 1, wherein it further comprises a recording step of recording, into said parts integration database, data on a resulting rejection determined by the authorized approver through said determination step when the approval for the integration of the existing parts and the new parts is rejected, together with a reason to reject the approval for the integration.

5. A parts sales mode control system adaptable to a life cycle comprising a master database, in which data on all parts including parts for new commercial products are previously existing, and which may be shared among related department terminal devices; a parts sales mode control database, which permits an exchange of data to and from said master database; and an examiner terminal device and an authorized approver terminal device, which are connectable to said parts sales mode control database, wherein the parts sales mode control system also comprises:
an extraction step of extracting parts-related data having been newly recorded in said master database within a certain period of time to copy extracted new parts data into said parts sales mode control database;
an examination step of comparing the new parts data obtained through said extraction step with existing parts-related data to allow an examiner to examine whether a change of the sales mode on the existing parts is possible or not;
an approval request step of sending a request to approve a resulting judgment, which is passed by the examiner through said examination step when the change of the sales mode on the existing parts is judged to be possible, to the authorized approver terminal device dedicated to an authorized approver who is authorized to make a final decision on the judgment of the examiner;
a determination step of allowing the authorized approver to determine the possibility or not of the change of the sales mode on the existing parts in accordance with said approval request step; and
an updating step of providing changed sales mode data by updating the existing parts sales mode-related data in said master database on the basis of approval data obtained at a time when the approval for the change of the sales mode on the existing parts is determined through said determination step.

6. The parts sales mode control system adaptable to the life cycle according to claim 5, wherein it further comprises a distribution step of distributing the changed sales mode data provided by updating through said updating step to said related department terminal devices.

7. The parts sales mode control system adaptable to the life cycle according to claim 5, wherein it further comprises a recording step of recording, into said parts sales mode control database, data on a resulting judgment passed by the examiner through said examination step when the change of the sales mode on the existing parts is judged to be impossible, together with a reason to judge the change of the sales mode to be impossible.

8. The parts sales mode control system adaptable to the life cycle according to claim 5, wherein it further comprises a recording step of recording, into said parts sales mode control database, data on a resulting rejection determined by the authorized approver through said determination step when the approval for the change of the sales mode on the existing parts is rejected, together with a reason to reject the approval for the change of the sales mode.
